(19) United States
(12) Patent Application Publication
(10) Pub. No.: US 2007/0230293 A1
(43) Pub. Date: Oct. 4, 2007

(54) METHOD FOR MOVING SLEDGE OF OPTICAL DISC DRIVE

(75) Inventor: Tso-Yu Chang, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On It Corp., Taipei City (TW)

(21) Appl. No.: 11/687,111

(22) Filed: Mar. 16, 2007

(30) Foreign Application Priority Data
Mar. 29, 2006 (TW) 095111041

(51) Int. Cl. G11B 7/00

(52) U.S. Cl. 369/44.28; 369/53.3

(57) ABSTRACT

A method for moving a sledge disposed thereon an optical pickup head of an optical disc drive is provided for controlling the motion of the sledge relative to an optical disc loaded. The optical disc drive further includes a sledge motor. At first, the sledge motor drives the sledge to move toward the center of the optical disc. At the same time, the tracks crossed by the optical pickup head are detected and counted according to a tracking error signal generated by the optical pickup head. When the count or an increment in the count within a specific period is not larger than a predetermined value or the tracking error signal is undetectable, the optical disc drive immediately stops the sledge motor from driving the sledge. The monitoring mechanism can avoid undesired impact and noises of the sledge.

### FIELD OF THE INVENTION

The present invention relates to a method for moving a sledge of an optical disc drive, and more particularly to a method for controlling an optical pickup head of the optical disc drive to move relative to an optical disc loaded.

### BACKGROUND OF THE INVENTION

In general, the internal structure of an optical disc drive includes an optical pickup head, a sledge mechanism, a spindle motor, and a disc tray. The optical pickup head is the main part for accessing data recorded in the optical disc. The disc tray is brought in or ejected to load or unload the optical disc in the optical disc drive. The other elements can drive the optical pickup head to move along a radial direction of the optical disc.

FIG. 1(a) is a perspective diagram depicting the internal structure of a conventional optical disc drive 100. The optical disc drive 100 includes a spindle motor 11, an optical pickup head 12, and a stepping motor 13, wherein the optical pickup head 12 is disposed on and carried by a sledge 121, and driven in a straight-line motion by a driving mechanism 14, which is connected to the stepping motor 13. In general, the driving mechanism 14 includes a gears and a lead screw (not shown) for driving the motion. After an optical disc 10 is mounted above the spindle motor 11, via the rotation of the spindle motor 11 and the radial-direction movement of the optical pickup head 12, data recorded at any position of the optical disc 10 can be accessed by the optical pickup head 12.

FIG. 1(b) is a bottom view depicting an internal structure of the optical disc drive 100. As described above, the optical pickup head 12 is disposed on the sledge 121, wherein the sledge 121 can slide along two bars 151 and 152. One end of the sledge 121 is engaged with a lead screw 141. When the lead screw 141 is driven to rotate by the stepping motor 13 and the related gears, the sledge 121 engaged with the lead screw 141 can be moved forward and backward along the bars 151 and 152.

Conventionally, when the conventional optical disc drive 100 is powered on and the optical disc 10 is loaded for data accessing, the sledge 121 must be moved close to the spindle motor 11 in response to the default setting in firmware, so that the optical pickup head 12 can read the disc information recorded in the inner zone of the optical disc 10 to recognize the type and the specification of the optical disc 10. However, for the universal use and cost-saving purpose, a limiting switch for monitoring the movement of the sledge 121 has been removed. Therefore, the optical disc drive 100 cannot detect when the sledge 121 is closing to, even contacting, the spindle motor 11. In general, for making sure the sledge 121 can be close enough to the spindle motor 11, the stepping motor 13 will drive the sledge 121 move toward the spindle motor 11 for a longer time. However, if the driving time is too long, this method may cause the sledge 121 to impact the spindle motor 11, so that an improper engagement between the sledge 121 and the lead screw 141 may occur, a deviation or a noise may be resulted in, and the performance of the whole mechanical structure may be even affected.

For fixing the above-described problems, a solution is proposed to adjust the driving time or the driving power of the stepping motor 13 is. However, trivial error or insufficient accuracy in the solution will seriously affect the performance. If the driving time is too short or the driving power is too low, the sledge 121 cannot be moved close enough to the spindle motor 11. On the contrary, if the driving time is too long or the driving power is too high, a stronger impact of the sledge 121 against the spindle motor 11 or a louder noise generated due to the friction between the sledge 121 and the lead screw 141 may be resulted in. Therefore, efforts are made to avoid the impact and the noise.

### SUMMARY OF THE INVENTION

A method for moving a sledge disposed thereon an optical pickup head of an optical disc drive is provided to overcome the above-mentioned impact and noise problems. The optical disc drive also includes a sledge motor for driving the sledge. At first, the sledge motor drives the sledge to move toward the center of the optical disc. At the same time, the tracks crossed by the optical pickup head are detected and counted. When the count or an increment in the count within a specific period is not larger than a predetermined value, the optical disc drive immediately stops the sledge motor from driving the sledge.

In an embodiment, the optical disc drive further includes a spindle motor for mounting thereon the optical disc and driving the optical disc to rotate. Whether the optical disc is loaded in the optical disc drive can be determined according to a rotating situation of the spindle motor.

In an embodiment, the optical pickup head emits a laser beam, and determines whether the optical disc is loaded in the optical disc drive according to a reflection situation of the laser beam.

In an embodiment, the crossed tracks are detected and counted according to a voltage of a tracking error signal or a radio frequency zero-crossing signal.

In an embodiment, the specific period is longer than the time period required for detecting two adjacent tracks on the optical disc. When the increment in the count within the specific period is equal to 0, the optical disc drive immediately stops the sledge motor from driving the sledge.

In an embodiment, the sledge motor may be implemented by a DC motor or a stepping motor.

According to another aspect of the present invention, a method for moving a sledge disposed thereon an optical pickup head of an optical disc drive is provided. At first, the sledge motor drives the sledge to move toward the center of the optical disc. At the same time, the optical pickup head detects a tracking error signal generated by the optical pickup head. When the tracking error signal is not detectable any more, the optical disc drive immediately stops the sledge motor from driving the sledge.

### BRIEF DESCRIPTION OF THE DRAWINGS

The above contents of the present invention will become more readily apparent to those ordinarily skilled in the art after reviewing the following detailed description and accompanying drawings, in which:

FIG. 1(a) is a perspective diagram illustrating an internal structure of a conventional optical disc drive 100;

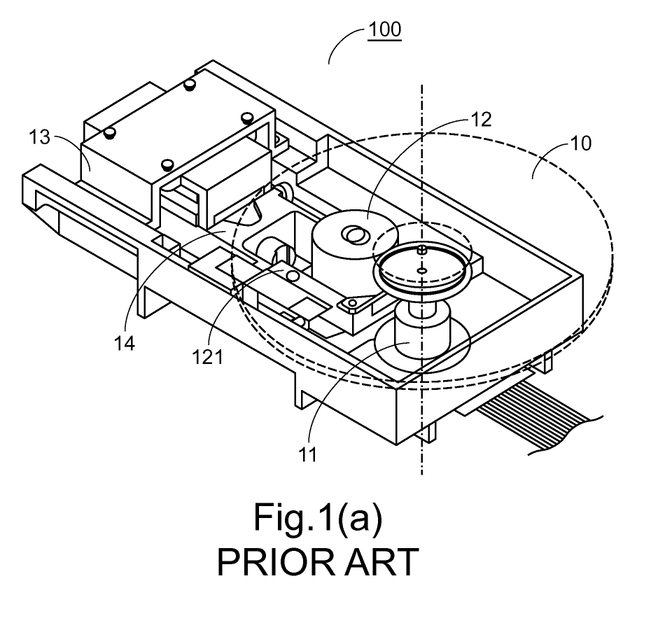

FIG. 1(b) is a bottom view illustrating the internal structure of the conventional optical disc drive 100;

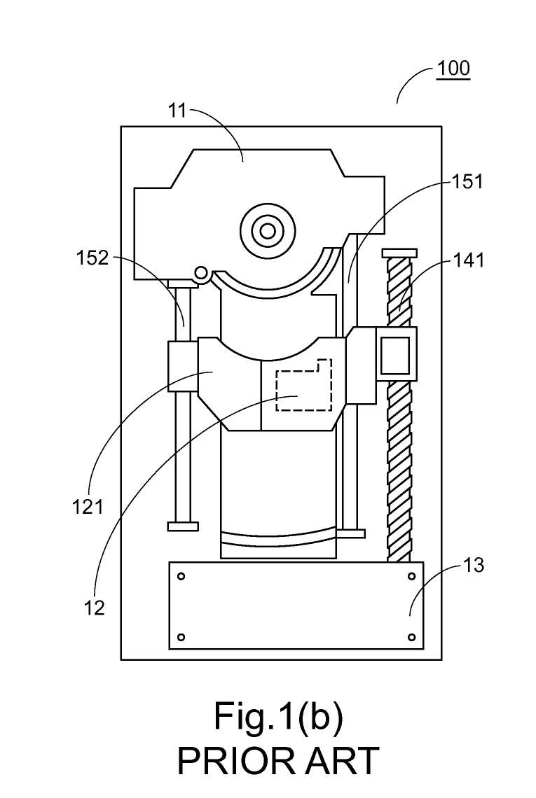

FIG. 2 is a bottom diagram illustrating an internal structure of an optical disc drive 200 with an optical disc loaded;

FIG. 3 is a flow chart illustrating a first preferred embodiment of moving the sledge of the optical disc drive in FIG. 2 according to the present invention; and

FIG. 4 is a flow chart illustrating a second preferred embodiment of moving the sledge of the optical disc drive in FIG. 2 according to the present invention.

### DETAILED DESCRIPTION OF THE PREFERRED EMBODIMENT

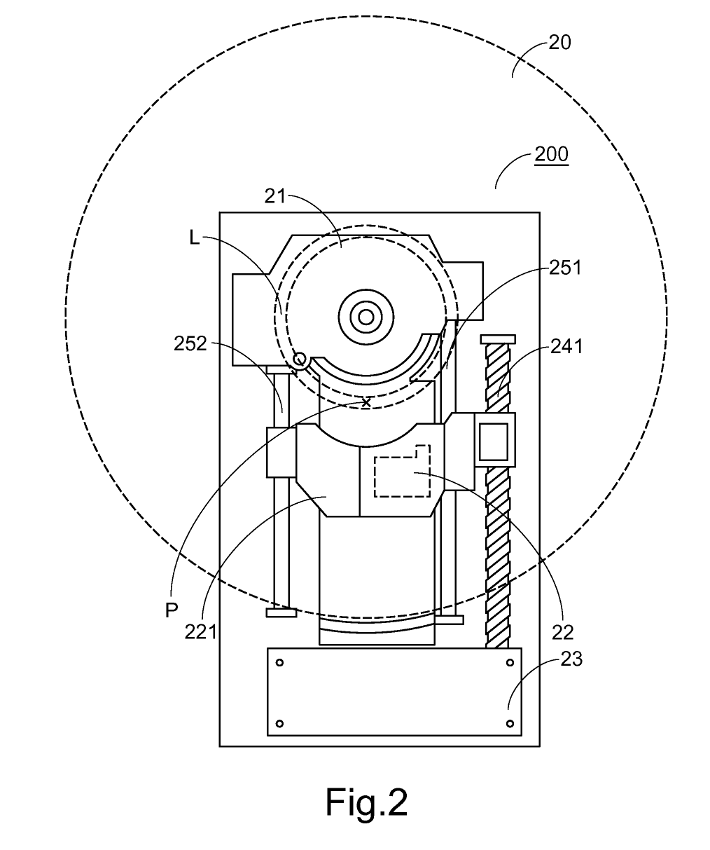

FIG. 2 is a bottom view illustrating an internal structure of an optical disc drive 200 applied to the present invention. The optical disc drive 200 includes a spindle motor 21, an optical pickup head 22, a sledge motor 23, implemented by a DC motor or a stepping motor for example, and a lead screw 241. The optical pickup head 22 is disposed on and carried by a sledge 221, and the sledge 221 can slide along bars 251 and 252. The threads on the lead screw 241 allow one end of the sledge 221 be engaged with the lead screw 241. When the lead screw 241 is driven by the sledge motor 23 to rotate, the optical pickup head 22 accompanied with the sledge 221 engaged with the lead screw 241 can be moved forward and backward along the bars 251 and 252. In addition, an optical disc 20 is mounted above the spindle motor 21 and rotated with the spindle motor 21.

There are a plurality of tracks arranged on a data layer of the optical disc 20, and the disc information, e.g. a type, a specification, or a media ID, is recorded in an inner zone of the optical disc 20, shown as the region L encircled by dotted lines in FIG. 2). For properly accessing data recorded in the optical disc 20, the disc information recorded in the inner zone L of the optical disc 20 must be read by the optical pickup head 22 first. The optical pickup head 22, together with the sledge 221, must be moved close enough to the point P near the spindle motor 21. In general, there is a specific distance between the inner zone L and a center hole of the optical disc 20. The outer edge of the inner zone L is adjacent to the most-inner-track. If a real-time monitoring mechanism is provided to monitor whether the optical pickup head 22 reaches the most-inner track, the sledge motor 23 can properly drive the lead screw 241 so as to avoid the improper engagement between the sledge 221 and the lead screw 241.

However, the sledge 221 is moved toward the point P only when the optical disc 20 is loaded in the optical disc drive 200. In this embodiment, a laser beam is emitted from the optical pickup head 22, and the reflection condition of the laser beam indicates whether the optical disc 20 is loaded in the optical disc drive 200. Since the sledge 221 can be at any position along the bars 251 and 252 in an initial state, for example, when a small-sized optical disc having a 80 mm-diameter is loaded in the optical disc drive 200 and the initial position of the sledge 221 is far away from the spindle motor 21, the laser beam emitted from the optical pickup head 22 cannot be reflected from the small-sized optical disc, and the optical disc drive 200 may consider that there is no optical disc loaded. It is an improper determination.

Because the weight of an optical disc will affect the rotating situation of the spindle motor 21, the above-described problem can be fixed by a rotating test. The rotating test executed by the spindle motor 21 is for determining whether the optical disc 20 is loaded in response to the rotating situation of the spindle motor 21. Therefore, even the laser beam emitted from the optical pickup head 22 cannot be reflected from the optical disc 20 but the optical disc 20 is indeed loaded, the optical disc drive 200 can still make a correct judgment. Then the sledge 221 will be moved toward the point P.

In this embodiment, a track detection operation will be also executed along with the moving of the optical pickup head 22 driven by the sledge 221. The track detection operation is used for detecting the tracks on the optical disc 20 during the optical pickup head 22 is moved toward the inner zone L of the optical disc. When the most-inner track of the optical disc 20 is detected, the sledge motor 23 immediately stops driving the lead screw 241, so that the sledge 221 will stop moving toward the spindle motor 21.

As described above, when the optical disc drive 200 detects that the optical disc 20 is loaded, it starts the track detection operation. Since the type and specification of the loaded optical disc 20 are still unknown at this time, a standard focusing setting is adopted for the track detection operation. Once the laser beam is reflected and detected, in indicates that the optical pickup head 22 approaches the optical disc 20 and moves toward the most-inner track.

In this embodiment, a voltage of a tracking error (TE) signal generated by the optical pickup head 22 can be used in the track detection operation. When the optical pickup head 22 is accessing data along a track, the voltage of the TE signal approaches 0. When the optical pickup head 22 is crossing the tracks, the voltage of the TE signal has a sinusoidal characteristic. Hence, we can judge if the optical pickup head is crossing the tracks according to the voltage of the TE signal.

In addition, the tracks that the optical pickup head 22 has crossed can be counted by executing a firmware program and updating the parameters of the optical disc drive 200.

Since the distance between every two adjacent tracks is identical on the optical disc 20, the count of tracks that the optical pickup head 22 has crossed should increase stably. If the count within a specific period is not larger than a predetermined value, even keeping at a fixed value, the optical pickup head 22 has crossed the most-inner track and is close to the spindle motor 21.

As described above, by counting the tracks that have been crossed, a driving power of the sledge motor 23 can be determined in response to the possible position of the optical pickup head 22. It is to be noted that when the optical pickup head 22 has crossed the most-inner track of the optical disc 20 and approaches the point p, the impact of the sledge 221 against the spindle motor 21 will occurs when the lead screw 241 further rotates one circle. Hence, when the optical pickup head 22 is detected to cross the most-inner track and approach the point p, a command sent from the optical disc drive 200 will immediately stop the sledge motor 23 from driving the sledge 221, and the front edge of the sledge 221 will stop at the point P, or a position close to the point P. The response time is very short. Therefore, the improper engagement between the sledge 221 and the lead screw 241 in the prior art can be avoided according to the present invention.

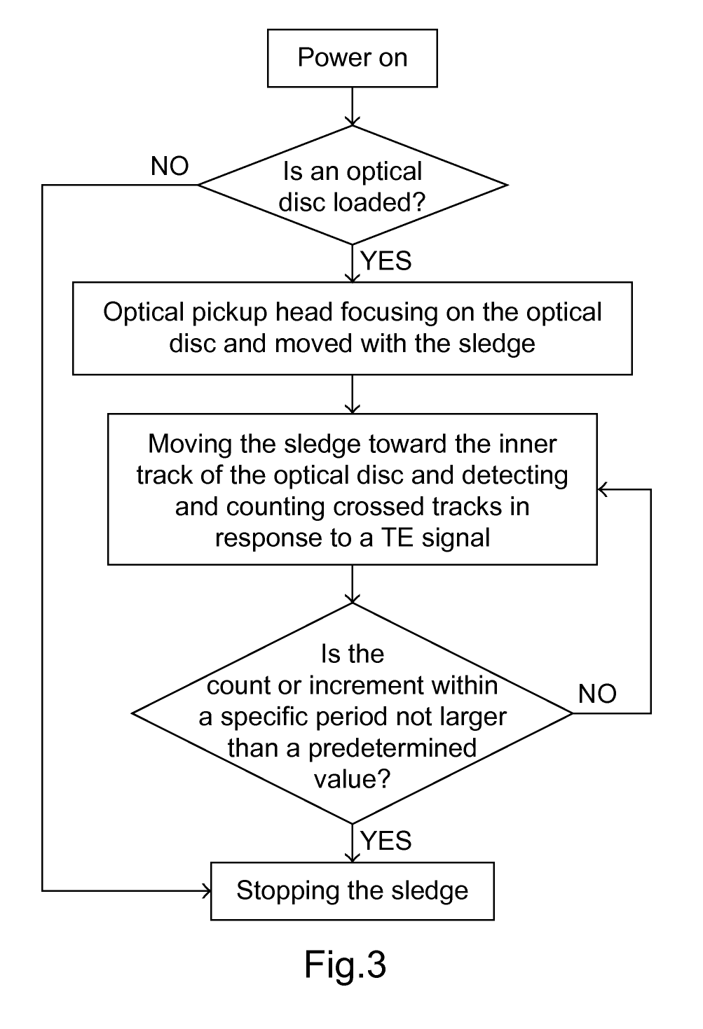

FIG. 3 is a flow chart illustrating a first preferred embodiment of moving the sledge of the optical disc drive according to the present invention. First, the user powers on the optical disc drive 200. Next, the optical disc drive 200 determines whether the optical disc 20 is loaded after the optical disc drive 200 is powered on. If the optical disc 20 has been loaded in the optical disc drive 200, the optical pickup head 22 focuses on the optical disc 20 to execute a track detection, and is moved with the sledge 221 driven by the lead screw 241 in response to a command sent from the optical disc drive 200 to the sledge motor 23. When the optical pickup head 22 is moved toward the spindle motor 21, a voltage of a TE signal, generated by the optical pickup head 22, can be used for detecting and counting the tracks that has been crossed by the optical pickup head 22. If the count or increment within a specific period is not larger than a predetermined value, for example, 0 for the increment, it indicates that the optical pickup head 22 has crossed the most-inner track of the optical disc 20. Thus, a command sent from the optical disc drive 200 will immediately stop the sledge motor 23 from driving the sledge 221, and the sledge 221 stops moving in response to the command.

However, there are many optical discs of different types and specifications released in market. The TE signals may have a poor quality, or even the TE signals may be undetectable, when the track detection is applied to some specific optical discs, so that the tracks are hard to be detected and counted. According to a further analyzing and testing, it is found that the TE signal always disappears just after the optical pickup head 22 is crossing the most-inner track, that is, entering the region L in FIG. 2. Therefore, the time point when the TE signal is undetectable can be another judging standard to indicate that the optical pickup head 22 has crossed the most-inner track of the optical disc 20, that is, the front edge of the sledge 221 is close to the point P.

Accordingly, the time point when the TE signal is undetectable is used for determining when sledge motor 23 should stop driving the sledge 221 in a second preferred embodiment. The other steps are the same as that in the first preferred embodiment of the present invention.

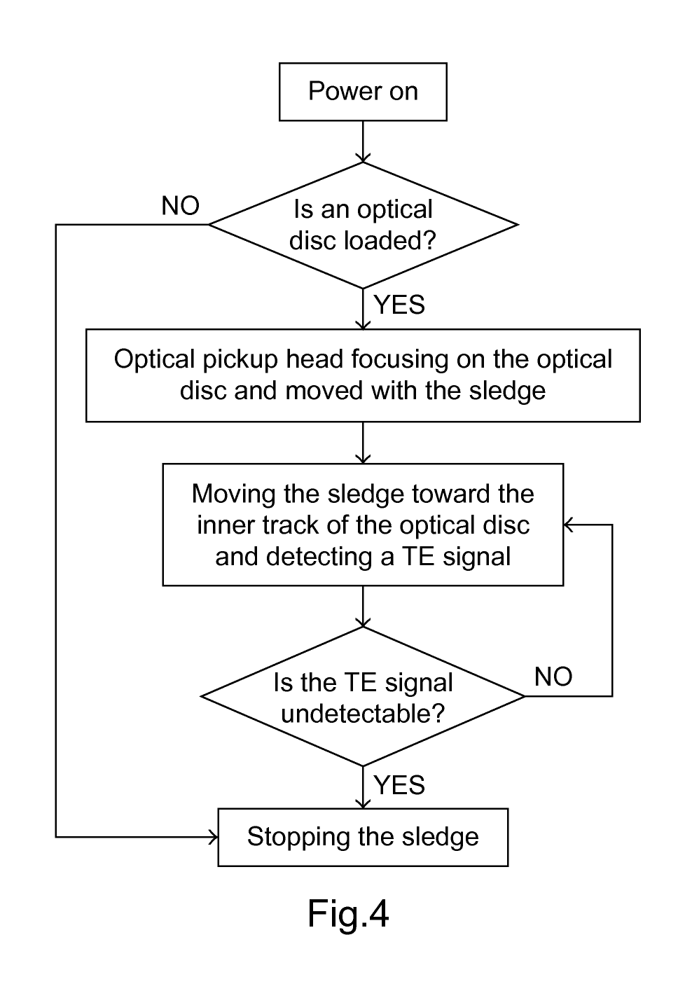

FIG. 4 is a flow chart illustrating the second preferred embodiment of moving the sledge of the optical disc drive according to the present invention. First, the user powers on the optical disc drive 200. Next, the optical disc drive 200 determines whether the optical disc 20 is loaded after the optical disc drive 200 is powered on. If the optical disc 20 has been loaded in the optical disc drive 200, the optical pickup head 22 focuses on the optical disc 20 to execute a track detection, and is moved with the sledge 221 driven by the lead screw 241 in response to a command sent from the optical disc drive 200 to the sledge motor 23. When the optical pickup head 22 is moved toward the spindle motor 21, a voltage of a TE signal, generated by the optical pickup head 22 can be used for the track detection. The TE signal is monitored. If the TE signal is undetectable, it indicates that the optical pickup head 22 has crossed the most-inner track of the optical disc 20. Thus, a command sent from the optical disc drive 200 will immediately stop the sledge motor 23 from driving the sledge 221, and the sledge 221 stops moving in response to the command.

The combination of the first and the second preferred embodiments of the present invention can applied to most optical discs in market. By carrying out the first and the second preferred embodiments, the moving of the sledge 221 can be controlled very well. In the above description, the TE signal is adopted to judge whether the optical pickup head 22 has crossed the most-inner track. Alternatively, a radio frequency zero-crossing (RFZC) signal or other suitable signals can be used to detect the tracks that the optical pickup head 22 has crossed. The RFZC signal has a better accuracy for detecting the tracks than that by the TE signal. Moreover, the RFZC signal can be also used for assisting in positioning the optical pickup head 22 and the sledge 221 when the TE signal is undetectable.

In conclusion, the present invention can overcome the problems such as the impact of the sledge against the spindle motor and the noises occurred due to improper engagement between the sledge and the lead threw while accessing the optical disc. While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A method for moving a sledge disposed thereon an optical pickup head of an optical disc drive comprising a sledge motor for driving the sledge, comprising steps of:
driving the sledge to move toward the center of an optical disc in a radial direction by the sledge motor after the optical disc is loaded in the optical disc drive;
detecting and counting tracks that the optical pickup head crosses; and
stopping the sledge motor from driving the sledge when the count or an increment in the count within a specific period is not larger than a predetermined value.

2. The method according to claim 1, wherein the optical disc drive further includes a spindle motor for mounting thereon the optical disc and driving the optical disc to rotate.

3. The method according to claim 2, wherein the method further comprises steps of:
driving the spindle motor to rotate; and
determining whether the optical disc is loaded in the optical disc drive according to a rotating situation of the spindle motor.

4. The method according to claim 1, wherein the method further comprises steps of:
emitting a laser beam on the optical disc by the optical pickup head; and
determining whether the optical disc is loaded in the optical disc drive according to the reflection situation of the laser beam.

5. The method according to claim 1, wherein the crossed tracks are detected and counted according to a voltage of a tracking error signal, generated by the optical pickup head focusing on the optical disc

6. The method according to claim 1, wherein the crossed tracks are detected and counted according to a radio frequency zero-crossing signal.

7. The method according to claim 1, wherein the specific period is longer than the time period required for detecting two adjacent tracks on the optical disc.

8. The method according to claim 7, wherein the predetermined value is 0, and the sledge motor is stopped from driving the sledge when the increment in the count within the specific period is equal to the predetermined value.

9. The method according to claim 1, wherein the sledge motor is one of a DC motor and a stepping motor.

10. A method for moving a sledge disposed thereon an optical pickup head of an optical disc drive comprising a sledge motor for driving the sledge, comprising steps of:
driving the sledge to move toward the center of an optical disc in a radial direction by the sledge motor after the optical disc is loaded in the optical disc drive;
generating a tracking error signal by the optical pickup head; and
stopping the sledge motor from driving the sledge when the tracking error is undetectable.

11. The method according to claim 10, wherein the optical disc drive further includes a spindle motor for mounting thereon the optical disc and driving the optical disc to rotate.

12. The method according to claim 11, wherein the method further comprises steps of:
driving the spindle motor to rotate; and
determining whether the optical disc is loaded in the optical disc drive according to a rotating situation of the spindle motor.

13. The method according to claim 10, wherein the method further comprises steps of:
emitting a laser beam on the optical disc by the optical pickup head; and
determining whether the optical disc is loaded in the optical disc drive according to the reflection situation of the laser beam.

14. The method according to claim 10, wherein the sledge motor is one of a DC motor and a stepping motor.
